(19) United States
(12) Patent Application Publication
(10) Pub. No.: US 2021/0316595 A1
(43) Pub. Date: Oct. 14, 2021

(54) End Line Assembly for a Heating Device of a Vehicle Fit for Habitation

(71) Applicant: Truma Gerätetechnik GmbH & Co. KG, Putzbrunn (DE)

(72) Inventors: Jens Bartusel, Rosenheim (DE); Markus Jäger, Höhenkirchen-Siegertsbrunn (DE)

(21) Appl. No.: 17/269,805

(22) PCT Filed: Aug. 20, 2019
(86) PCT No.: PCT/EP2019/072230

§ 371 Date: Feb. 19, 2021

(30) Foreign Application Priority Data
Aug. 21, 2018 (DE) 10 2018 120 396.9

(51) Int. Cl. B60H 1/22

(52) U.S. Cl. CPC B60H 1/2203; B60H 2001/2281

(57) ABSTRACT

The invention relates to an end line assembly (10) for a heating device (30) of a vehicle (42) fit for habitation, in particular a caravan, motorhome or ship, comprising: at least one exhaust-gas pipe portion (16-1, 16-2) for leading away exhaust gases of an associated burner of the heating device (30); at least one combustion air pipe portion (18) for feeding combustion air to an associated burner of the heating device (30), the exhaust-gas pipe portion (16-1, 16-2) and the combustion air pipe portion (18) being parallel to one another and immovable in a sleeve portion (20), the outside (22) of which delimits the line assembly (10) with respect to the surroundings.

The invention relates to an end line assembly for a heating device of a vehicle fit for habitation, in particular, a caravan, motor home or ship.

In the arrangement of heating devices on or in vehicles fit for habitation, it is required, depending on the type of the heating device used that can include one or more burners, and, depending on its accommodation within a component or compartment of the vehicle, to provide a safe discharge of exhaust gases and a sufficient feed of combustion air. In this process, it is particularly desirable that preferably few or preferably small openings must be provided in the body shell of the vehicle or of the superstructure fit for habitation. For the discharge of exhaust gases and for the feed of combustion air, two pipes or lines separate from one another are provided in well-known systems. The number of separate lines increases in the case of a heating device including two burners (an alternative designation is heat-producing appliance) of which one is used for heating air and the other for heating water.

Heating devices comprising end line assemblies are known from FR 787 389 A, U.S. Pat. No. 4,621,609 A and EP 1 227 276 A2.

The invention is based on the object to provide a vehicle fit for habitation comprising an end line assembly in which a discharge of exhaust gases in accordance with the regulations, while avoiding exhaust gas backflows into one of the other lines and/or exhaust gas collections, especially underneath the vehicle floor, is enabled.

The object is achieved by a vehicle fit for habitation having the features of claim 1. Embodiments of the invention are stated in the dependent claims.

To this end, an end line assembly for a heating device of a vehicle fit for habitation, in particular, a caravan, motor home or ship, is stated, comprising:
at least one exhaust gas pipe section to discharge exhaust gases of an associated burner of the heating device;
at least one combustion air pipe section to feed combustion air to an associated burner of the heating device,
wherein the exhaust gas pipe section and the combustion air pipe section are provided relatively parallel to one another and immovable in a sleeve section, the outside of which delimits the line assembly from the surroundings.

The common accommodation of the exhaust gas pipe section and the combustion air pipe section within a sleeve section enables a compact design of the line assembly. Since the sleeve section delimits the line assembly from the surroundings, only one opening in a vehicle wall is required to enable the outlet of both the exhaust gas line and of the combustion air line.

In this process, the sleeve section can be formed by the combustion air pipe section. In this case, the combustion air pipe section forms the outer boundary of the line assembly from the surroundings. In this process, the at least one exhaust gas pipe section is arranged within the combustion air pipe section. A compact design of the line assembly is thereby achieved.

The end line assembly can include at least two exhaust gas pipe sections which are separated fluidically from one another. Such a line assembly can be used for a heating device comprising at least two burners (or two heat-producing appliances), where each exhaust gas pipe section can, in each case, be fluidically connected or is fluidically connected to an associated burner. In this process, the two exhaust gas pipe sections are commonly accommodated within the sleeve section or within the combustion air pipe section forming the sleeve section. This also enables a compact design of the line assembly, so that also two exhaust gas lines together with a combustion air line can easily be arranged in the area of the body shell of the vehicle or led out of the vehicle.

In the end line assembly, the combustion air pipe section can surround the exhaust gas pipe section(s) in such a manner that the exhaust gas pipe section(s) is(are) surrounded by combustion air.

Furthermore, the exhaust gas pipe section(s) and the combustion pipe section can be arranged concentrically to one another in the end line assembly. A compact line assembly that can easily be connected can thereby be provided. In the case of a line assembly comprising two exhaust gas pipe sections, a first exhaust gas pipe section can, for example, be designed circular in the cross section and form the center of the concentric line assembly. The second exhaust gas pipe section can, in such a case, be arranged annularly around the first exhaust gas pipe section. Finally, in such a configuration, the combustion air pipe section can be designed annular around the second exhaust gas pipe section. In this process, the combustion air pipe section can delimit the line assembly outwardly.

The line assembly can comprise a line end piece, which, on its side facing away from the heating device, forms an outlet for the exhaust gas pipe section(s) and the combustion air pipe section. In this process, the line end piece can be inserted into a wall of the vehicle fit for habitation, in particular, can be mounted therein. Alternatively, such a line end piece can also be provided in a wall of a compartment which is arranged underneath the floor of the interior, also so-called underfloor, and within which a heating device is arranged underfloor.

The line assembly can comprise an extension piece, which includes at least one bent line section which is arranged between a first extension section and a second extension section, where the first extension section is, related to the direction of flow of exhaust gas, arranged upstream of the bent line section. Such an extension piece enables the discharge of exhaust gases into an area which is located further away from the heating device. In particular, such an extension piece enables that exhaust gases coming from a heating device arranged underfloor and emitted underneath the vehicle floor are discharged at a site that is not located underfloor, but preferably is positioned higher than the vehicle floor.

The extension piece can include a fastening means in such a manner that the extension piece, in particular, the second extension section, can be fixed on a wall of the vehicle fit for habitation. Thus, the extension piece can be safely fastened or secured on the vehicle by means of its connection in the area of the heating device and by means of the fastening means.

The extension piece can include a first bent line section, which is arranged between the first extension section and the second extension section, and a second bent line section which is, related to the direction of flow of exhaust gas, arranged downstream on the second extension section. Furthermore, the first extension section and the second extension section are aligned essentially orthogonally to one another. Thus, it is possible that the exhaust gas line is, by means of the extension piece, routed from underfloor to an edge of the vehicle floor and then routed upward along a wall of the vehicle.

The line assembly can comprise a line adapter directly or indirectly connected to the heating device, on which the line end piece or the extension piece is removably mounted, especially in the style of a plug connection. In this process, the line adapter has, in relation to the arrangement of exhaust gas pipe section(s) and combustion air pipe section, the same configuration as the line end piece or extension piece to be connected. Such a line adapter can, for example, serve to merge individual exhaust gas lines or combustion air lines exiting from the heating device, so that the individual lines can then be fluidically connected to the end line assembly.

The line end piece can, related to the direction of flow of exhaust gas, be mounted on the extension piece downstream of the second extension section. In other words, for example, an end piece used in a wall can, for example, be removed, and instead the extension piece can be mounted, where the end piece can then be put onto the free end of the extension piece.

The invention further relates to a heating system for a vehicle fit for habitation, in particular, a caravan, motor home or ship, comprising a heating device for heating air inside the vehicle and/or for heating water, with the heating device for discharging exhaust gases of one or more burners and for feeding combustion air to the burner or to the burners including an aforedescribed end line assembly.

In the heating system, at least one flexible exhaust gas pipe section and at least one flexible combustion air pipe section can be arranged fluidically between the heating device and the end line assembly. In this process, the flexible exhaust gas pipe section or a plurality of flexible exhaust gas pipe sections can be accommodated within the flexible combustion pipe section. Alternatively, the at least one flexible exhaust gas pipe section and the flexible combustion air pipe section can be designed as separate or parallel lines. As already discussed above, such flexible line sections can, for example, be connected to a line adapter of the line assembly.

Finally, the invention also relates to a vehicle fit for habitation, in particular, a caravan, motor home or ship, comprising an aforedescribed heating system or an aforedescribed line assembly.

In the vehicle fit for habitation, the heating device can be accommodated within a compartment separated from the interior by a covering means, where the compartment is designed as an underfloor compartment underneath the floor of the interior or as a floor-mounted compartment through side walls delimiting the interior.

Furthermore, in the vehicle fit for habitation, the end line assembly, in particular, its extension piece, can be arranged completely outside the interior of the vehicle in the heating device arranged within the underfloor compartment. Alternatively, in the vehicle fit for habitation, the end line assembly, in particular, its extension piece, can be arranged completely outside the interior of the vehicle in the heating device arranged underneath the floor of the interior. In this process, the extension piece can, additionally to the fluidical connection in the area of the underfloor compartment, be detachably fixated on an outside of a side wall of the vehicle by means of a fastening means.

In the following text, the invention is exemplarily and non-restrictingly described in more detail based on various embodiments with reference to the accompanying figures, in which

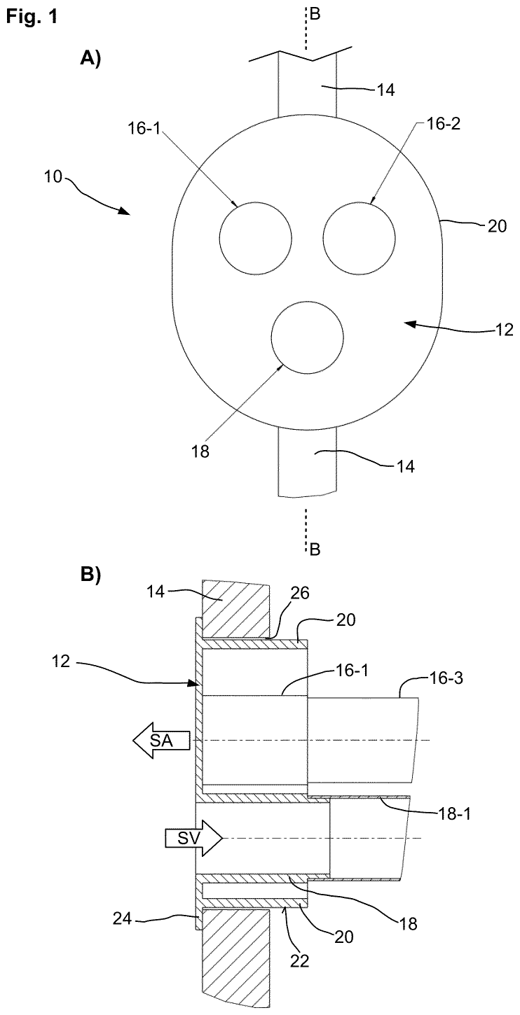

FIG. 1 shows a schematic and simplified plan view (FIG. 1A) and an associated sectional view (FIG. 1B) according to section line B-B of a first example of a line end piece of an end line assembly;

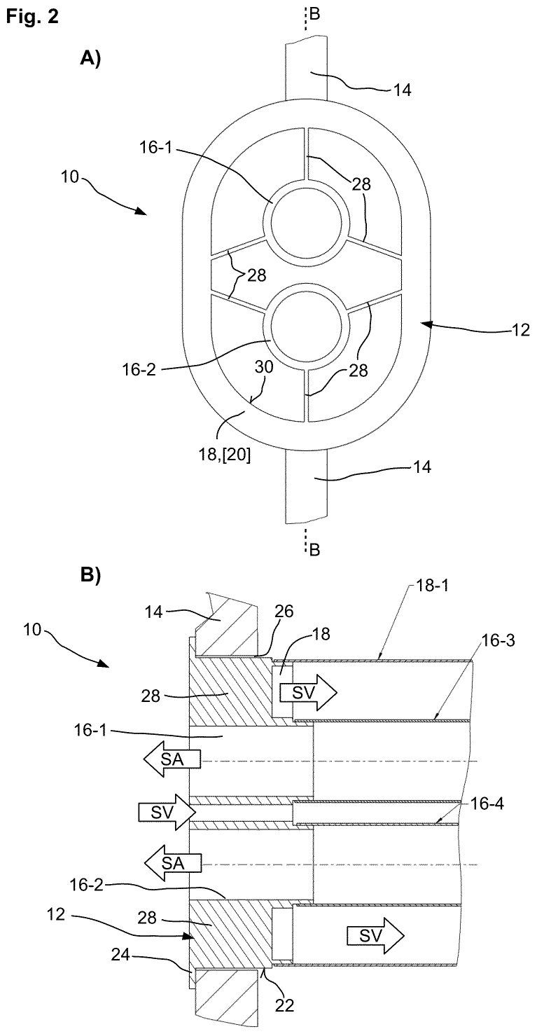

FIG. 2 shows a schematic and simplified plan view (FIG. 2A) and an associated sectional view (FIG. 2B) according to section line B-B of a second example of a line end piece of an end line assembly;

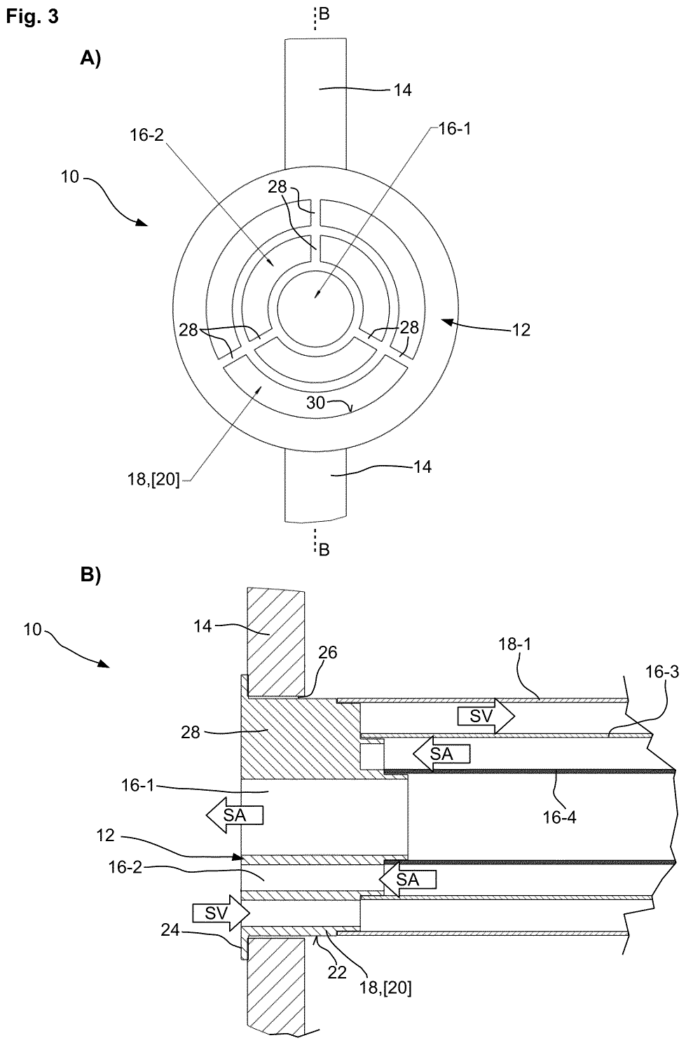

FIG. 3 shows a schematic and simplified plan view (FIG. 3A) and an associated sectional view (FIG. 3B) according to section line B-B of a third example of a line end piece of an end line assembly;

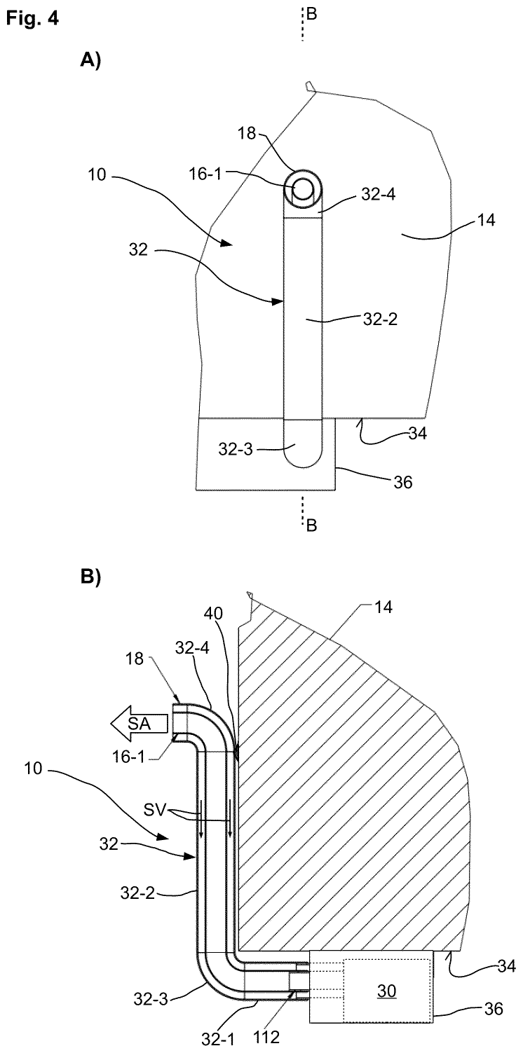

FIG. 4 shows a schematic and simplified plan view (FIG. 4A) and an associated sectional view (FIG. 4B) according to section line B-B of a first example of an extension piece of an end line assembly;

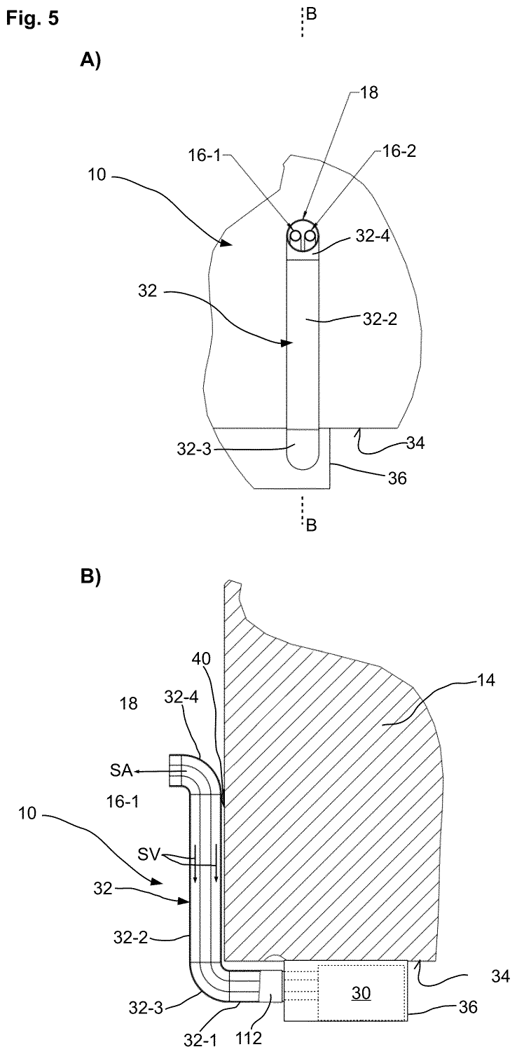

FIG. 5 shows a schematic and simplified plan view (FIG. 5A) and an associated sectional view (FIG. 5B) according to section line B-B of a second example of an extension piece of an end line assembly;

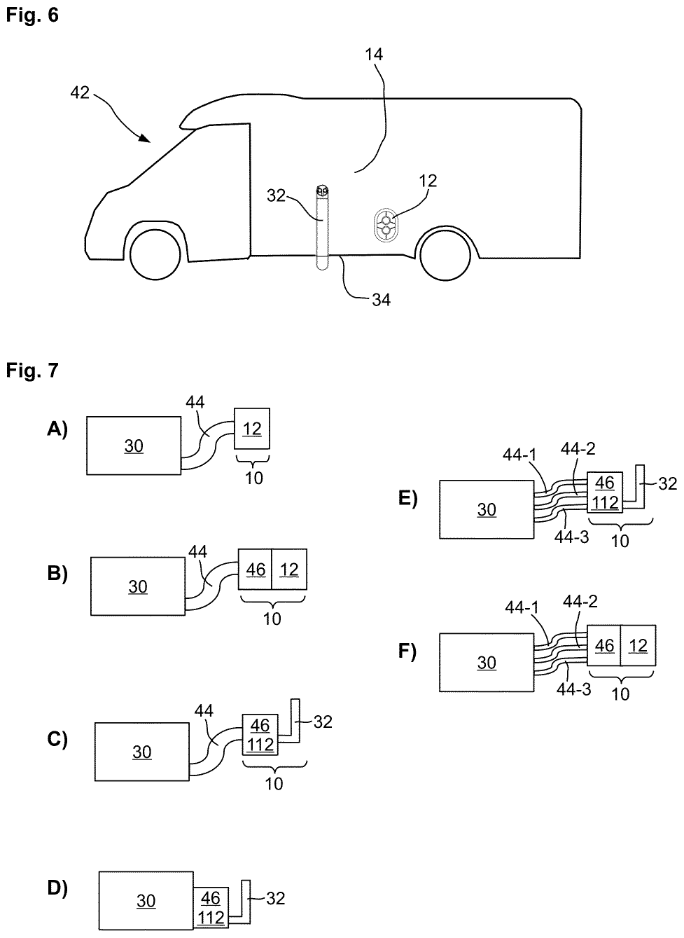

FIG. 6 shows a schematic and simplified view of a vehicle fit for habitation, on which, by way of example, a line end piece or an extension piece is arranged on an end line assembly;

FIG. 7 shows schematic representations of possible configurations of an end line assembly in partial FIGS. A) to F).

In all subsequent figures, a direction of flow SA of exhaust gas is characterized by a correspondingly designated arrow. The direction of flow SV of combustion air sucked in from the surroundings is opposite to the direction of exhaust gas flow SA.

FIG. 1 shows, in a schematic and simplified form, an end line assembly 10 for a heating device of a vehicle fit for habitation. The following description relates both to the plan view (FIG. 1A) and to the sectional view (FIG. 1B). The line assembly 10 includes a line end piece 12 which, in the example shown, is arranged in a wall 14, for example, a wall of the vehicle fit for habitation or a wall of a compartment within which the heating device is accommodated.

The line end piece 12 includes a first exhaust gas pipe section 16-1 for discharging exhaust gases. Furthermore, the line end piece 12 includes a second exhaust gas pipe section 16-2. A combustion air pipe section 18, which serves to feed combustion air to an associated burner of the heating device, is arranged underneath the two exhaust gas pipe sections 16-1, 16-2. In this process, the two exhaust gas pipe sections 16-1, 16-2 and the combustion pipe section 18 are provided relatively parallel to one another and immovable in a sleeve section 20. The outside 22 of the sleeve section 20 delimits the line assembly from the surroundings. In this example, the line end piece 12 is designed in such a manner that it also includes a cover plate 24 in which the outlets of the various pipe sections 16-1, 16-2, 18 are formed and which serves to cover an opening 26 provided in the wall 14, within which the line end piece 12 is accommodated.

Further exhaust gas pipe sections 16-3 or combustion pipe sections 18-1 can be connected to the line end piece 12. These line sections 16-3, 18-1 can be designed rigid or flexible. Preferably, the pipe sections 16-3 and 18-1 are designed in such a manner that the line end piece 12 can be easily connected to its pipe sections 16-1, 16-2, 18, in particular, by forming a plug connection. It is also conceivable that flexible pipe sections 16-3, 18 are mounted on the line end piece 12 by means of pipe clips not shown therein.

FIG. 2 shows again, in a schematic and simplified form, an end line assembly 10 for a heating device of a vehicle fit for habitation. The following description relates both to the plan view (FIG. 2A) and to the sectional view (FIG. 2B). The line assembly 10 includes a line end piece 12 which, in the example shown, is arranged in a wall 14, for example, a wall of the vehicle fit for habitation or a wall of a compartment within which the heating device is accommodated.

The line end piece 12 includes a first exhaust gas pipe section 16-1 for discharging exhaust gases. Furthermore, the line end piece 12 includes a second exhaust gas pipe section 16-2. The two exhaust gas pipe sections 16-1, 16-2 are surrounded by a combustion air pipe section 18, which serves to feed combustion air to an associated burner of the heating device. In this process, the two exhaust gas pipe sections 16-1, 16-2 and the combustion pipe section 18 are provided relatively parallel to one another and immovable.

In contrast to FIG. 1, for example, the combustion air pipe section 18 forms the sleeve section 20 shown separately in FIG. 1. The outside 22 of the combustion air pipe section 18 delimits the line assembly 10 from the surroundings. In this example, the line end piece 12 is designed in such a manner that it also includes a cover plate 24 in which the outlets of the various pipe sections 16-1, 16-2, 18 are formed and which serves to cover an opening 26 provided in the wall 14, within which the line end piece 12 is accommodated.

The two exhaust gas pipe sections 16-1, 16-2 are connected to the surrounding combustion air pipe section 18 by means of brace-like elements 28. In the example shown, each exhaust gas pipe section 16-1, 16-2 is supported on the combustion air pipe section 18 by means of three braces 28. Further exhaust gas pipe sections 16-3, 16-4 or combustion pipe sections 18-1 can be connected to the line end piece 12. These line sections 16-3, 16-4, 18-1 can be designed rigid or flexible. The pipe sections 16-3, 16-4 and 18-1 are preferably designed in such a manner that the line end piece 12 can be easily connected to its pipe sections 16-1, 16-2, 18, in particular, by forming a plug connection. It is also conceivable that flexible pipe sections 16-3, 16-4, 18-1 are mounted on the line end piece 12 by means of pipe clips not shown therein.

FIG. 3 shows again, in a schematic and simplified form, an end line assembly 10 for a heating device of a vehicle fit for habitation. The following description relates both to the plan view (FIG. 3A) and to the sectional view (FIG. 3B). The line assembly 10 includes a line end piece 12 which, in the example shown, is arranged in a wall 14, for example, a wall of the vehicle fit for habitation or a wall of a compartment within which the heating device is accommodated.

The line end piece 12 includes a first exhaust gas pipe section 16-1 for discharging exhaust gases. Furthermore, the line end piece 12 includes a second exhaust gas pipe section 16-2. The two exhaust gas pipe sections 16-1, 16-2 are surrounded by a combustion air pipe section 18, which serves to feed combustion air to an associated burner of the heating device. In this process, the two exhaust gas pipe sections 16-1, 16-2 and the combustion pipe section 18 are provided relatively parallel to one another and immovable. In this example, the exhaust gas pipe sections 16-1, 16-2 and the combustion air pipe section 18 are arranged concentrically to one another. In this process, the first exhaust gas pipe section 16-1 has a circular cross section. The second exhaust gas pipe section 16-2 is, in the cross section, arranged annularly around the first exhaust gas pipe section 16-1. The combustion air pipe section 18 is, in the cross section, arranged annularly around the second exhaust gas pipe section 16-2.

As in the example of FIG. 2 (and in contrast to the example of FIG. 1), the combustion air pipe section 18 forms the sleeve section 20 shown separately in FIG. 1. The outside 22 of the combustion air pipe section 18 delimits the line assembly 10 from the surroundings. In this example, the line end piece 12 is designed in such a manner that it also includes a cover plate 24 in which the outlets of the various pipe sections 16-1, 16-2, 18 are formed and which serves to cover an opening 26 provided in the wall 14, within which the line end piece 12 is accommodated.

The two exhaust gas pipe sections 16-1, 16-2 are connected to the surrounding combustion air pipe section 18 or to one another by means of brace-like elements 28. In the example shown, the first exhaust gas pipe section 16-1 is supported on the second exhaust gas pipe section 16-2 by means of three braces 28. The second exhaust gas pipe section 16-2 is again supported on the combustion air pipe section 18 by means of three braces 28. Further exhaust gas pipe sections 16-3, 16-4 or combustion pipe sections 18-1 can be connected to the line end piece 12. These line sections 16-3, 16-4, 18-1 can be designed rigid or flexible. The pipe sections 16-3, 16-4 and 18-1 are preferably designed in such a manner that the line end piece 12 can be easily connected to its pipe sections 16-1, 16-2, 18, in particular, by forming a plug connection. It is also conceivable that flexible pipe sections 16-3, 16-4, 18-1 are mounted on the line end piece 12 by means of pipe clips not shown therein.

FIG. 4 shows again, in a schematic and simplified form, an end line assembly 10 for a heating device 30 (indicated by dotted lines) of a vehicle fit for habitation. The following description relates both to the plan view (FIG. 4A) and to the sectional view (FIG. 4B). The line assembly 10 includes an extension piece 32 which, in the example shown, is arranged along a wall 14 and an underside 34, for example, a wall and an underside of the vehicle fit for habitation.

The extension piece 32 includes a first exhaust gas pipe section 16-1 for discharging exhaust gases. The exhaust gas pipe section 16-1 is surrounded by a combustion air pipe section 18, which serves to feed combustion air to an associated burner of the heating device 30. In this process, the exhaust gas pipe section 16-1 and the combustion pipe section 18 are provided relatively parallel to one another and immovable. In this example, the exhaust gas pipe section 16-1 and the combustion air pipe section 18 are arranged concentrically to one another. In this process, the first exhaust gas pipe section 16-1 has a circular cross section. The combustion air pipe section 18 is, in the cross section, arranged annularly around the first exhaust gas pipe section 16-1.

In this example, the indicated heating device 30 is accommodated underfloor within a compartment 36. A line end piece 112, which is modified compared to FIGS. 1 to 3, is located in a side wall 38 of the compartment 36. The modified line end piece 112 usually forms the free end of the end line assembly 10, so that exhaust gases are emitted underfloor, i.e. underneath the floor of the vehicle or of the vehicle superstructure fit for habitation, and correspondingly also combustion air is sucked in underfloor. In an alternative—not shown—embodiment, the heating device 30 is designed in such a manner that it itself is mounted underfloor and therefore free of a compartment.

Under certain circumstances, it can be desirable that the exhaust gas does not effuse underfloor, but at another site which especially is not underfloor and which preferably is located higher than the modified line end piece 112. To that end, the extension piece 32 can be optionally used. In this process, it is envisaged that the extension piece can be connected to the modified line end piece 112, if required.

In the present example, the extension piece 32 includes a first extension section 32-1 and a second extension section 32-2. The two extension sections 32-1, 32-2 are connected to one another by means of a bent line section 32-3. As can easily be seen from the representation of FIG. 4B, the first extension section 32-1 and the second extension section 32-2 are arranged essentially orthogonally to one another. Another bent line section 32-4 can connect to the second extension section 32-2. The extension sections can be formed together in one piece so that the extension piece 32 is an integral component. Alternatively, the extension sections also can be pluggable, so that the extension piece 32 can, disassembled into individual extension sections, be carried along in the vehicle fit for habitation.

A fastening means 40 can be provided in an upper area of the extension piece 32, for example, in the second extension section 32-2. The fastening means 40 especially serves to secure the extension piece 32 on the wall 14 of the vehicle. The fastening means 40 can, for example, be designed as a suction cup, which is mounted on the extension piece 32 and the suction side of which is brought into contact with or is in contact with the wall 14.

Also other types of fastening means are conceivable, one especially thinks of fastening means where complementary fastening elements are provided on the extension piece 32 and the wall 14, through which a form-fit and/or force-fit connection can be produced, if required. For example, a kind of eyelet or opening is provided on the wall 14, into which a hook element mounted on the extension piece 32 can be hooked. Furthermore, also a snap-on connection, for example, with a snap-on element projecting from the extension piece 32 which can be releasably engaged with a snap-on opening provided on the wall 14, is possible as the fastening means.

FIG. 5 shows again, in a schematic and simplified form, an end line assembly 10 for a heating device 30 (indicated by dotted lines) of a vehicle fit for habitation. The following description relates both to the plan view (FIG. 5A) and to the sectional view (FIG. 5B). The line assembly 10 includes an extension piece 32 which, in the example shown, is arranged along a wall 14 and an underside 34, for example, a wall and an underside of the vehicle fit for habitation.

The extension piece 32 has a first exhaust gas pipe section 16-1 and a second exhaust gas pipe section 16-2 for discharging exhaust gases. The exhaust gas pipe sections 16-1, 16-2 are surrounded by a combustion air pipe section 18, which serves to feed combustion air to an associated burner of the heating device 30. In this process, the exhaust gas pipe sections 16-1, 16-2 and the combustion pipe section 18 are provided relatively parallel to one another and immovable. In this example, the first exhaust gas pipe section 16-1 and the second exhaust gas pipe section 16-2 are arranged side by side and accommodated within the combustion air pipe section 18.

With regard to further features of the extension piece 32 and its arrangement, reference is made to the description regarding FIG. 4, which is also applicable to the example of FIG. 5. Accordingly, further reference numerals are stated in FIG. 5, which, however, have been described with regard to FIG. 4.

With reference to FIGS. 1 to 5, it is pointed out that the various arrangements of exhaust gas pipe sections 16-1, 16-2 and combustion air pipe sections 18, such as side by side, on top of one another, into one another, concentric, can be implemented both for the line end pieces 12 and for the extension piece 32. This means that each arrangement shown for a line end piece 12 can be implemented for an extension piece 32 or vice-versa. This, naturally, also applies to the line end piece 112 shown in FIG. 5.

FIG. 6 shows a highly simplified and schematic view of a vehicle 42 fit for habitation, in this case a motor home. The arrangement of a line end piece 12 of an end line assembly is shown, by way of example, in a side wall 14 of the vehicle 42 fit for habitation. The line end piece 12 shown corresponds to the example of FIG. 2. Instead of the line end piece 12 of FIG. 2, also other line end pieces 12 can be arranged on the vehicle 42, such as the line end pieces of FIGS. 1 and 3.

Furthermore, the arrangement of an extension piece 32 of the end line assembly is shown, by way of example, in FIG. 6. The extension piece 32 of FIG. 5 is, by way of example, shown with two exhaust gas pipe sections. As has already been explained with reference to FIGS. 4 and 5, the extension piece 32 is connected or connectable to a heating device arranged underfloor, which is provided on an underside 34 of the vehicle 42 or of the vehicle super-structure. Naturally, also the extension piece 32 according to FIG. 4 can be provided on a vehicle 42.

Even if the line end piece 12 and the extension piece 32 are shown together on the vehicle 42 in FIG. 6, it is pointed out that usually both are not provided on the same vehicle. Furthermore, it is pointed out that the line end piece 12 and the extension piece are not shown true to scale in relation to the vehicle 42. Rather, they are drawn magnified for the purpose of better understanding.

FIG. 7 shows, purely schematically, various embodiments or configurations of an end line assembly 10 with regard to an associated heating device 30 in partial FIGS. A) to F).

According to FIG. 7A, the line end piece 12 (see FIGS. 1 to 3) is connected to the heating device 30 by means of flexible pipes 44. In this process, the flexible pipes 44 are routed in such a manner that a corresponding connection to the exhaust gas pipe sections 16-1, 16-2 and the combustion air pipe section 18 can be enabled in the line end piece 12. In the example of FIG. 7A), the line end piece 12 can, for example, be inserted according to FIGS. 2 and 3. In such a configuration, the end line assembly only includes the line end piece 12.

According to FIG. 7B, a line adapter 46 is mounted on the line end piece 12, which is then connected to the flexible pipes 44. In this process, the line adapter 46 is particularly designed in such a manner that the line end piece 12 can be plugged onto the line adapter. In such a configuration, the end line assembly includes the line adapter 46 and the line end piece 12. In this process, plugging-in is an example of a rapid fastening system. An alternative comprises, for example, a bayonet system.

According to FIG. 7C, an extension piece 32 (FIGS. 4 and 5) is mounted on flexible pipes 44 by means of a line adapter 46. The line adapter shown therein can also be designed or understood as a line end piece 112 within the meaning of FIG. 5. In such a configuration, the end line assembly 10 includes the line adapter 46 or the line end piece 112 and the extension piece 32.

According to FIG. 7D, also a configuration is conceivable where a line adapter 46 is directly mounted on the heating device, and the extension piece 32 is provided on the line adapter 46. As in the example of FIG. 7C, the line adapter 46 can also be designed as a line end piece within the meaning of FIG. 5. In such a configuration, the end line assembly 10 includes the line adapter 46 or the line end piece 112 and the extension piece 32.

According to FIGS. 7E and 7F, individual lines 44-1, 44-2, 44-3 connected to a heating device 30 can be connected to a line adapter 46. The line adapter can then be connected to a line end piece 12 (FIG. 7F) or an extension piece 32 (FIG. 7E). In this process, the line adapter 46 is designed in such a manner that the individual lines 44-1, 44-2, 44-3 on the side of the heating device are fluidically merged in such a manner that the line end piece 12 or the extension piece 32 can, at the end of the line adapter 46, be connected to the arrangements of exhaust gas pipe sections 16-1, 16-2 and combustion air sections 18 shown in FIGS. 1 to 5. In a configuration according to FIG. 7E, the end line assembly 10 includes the adapter 46 or the line end piece 112 and the extension piece 32. In a configuration according to FIG. 7F, the end line assembly 10 includes the adapter 46 and the line end piece 12.

1-10. (canceled)

11. A vehicle fit for habitation, comprising:
a heating system with a heating device configured to heat air inside the vehicle and/or to heat water,
wherein the heating device is configured to discharge exhaust gases of one or more burners and to feed combustion air to the one or more burners,
wherein the heating device comprises an end line assembly,
wherein the end line assembly comprises at least one exhaust gas pipe section configured to discharge exhaust gases of an associated burner of the heating device and at least one combustion air pipe section configured to feed combustion air to an associated burner of the heating device,
wherein the at least one exhaust gas pipe section and the at least one combustion air pipe section are provided relatively parallel to one another and immovable in a sleeve section, an outside of which delimits the end line assembly from the surroundings,
wherein the heating device is accommodated within a compartment separated from an interior by a covering means,
wherein the compartment is designed as an underfloor compartment underneath a floor of the interior,
wherein the end line assembly is arranged completely outside the interior of the vehicle,
wherein the end line assembly comprises a line end piece having a side facing away from the heating device and that forms an outlet for the at least one exhaust gas pipe section and the at least one combustion air pipe section,
wherein the end line assembly comprises an extension piece which includes at least one bent line section arranged between a first extension section and a second extension section,
wherein the first extension section is, related to a direction of flow of exhaust gas, arranged up-stream of the at least one bent line section,
wherein the end line assembly comprises a line adapter directly or indirectly connected to the heating device, on which the line end piece or the extension piece is removably mounted.

12. The vehicle of claim 11, wherein the end line assembly comprises at least two exhaust gas pipe sections separated fluidically from one another.

13. The vehicle of claim 11, wherein the extension piece comprises a fastening means such that the second extension section is fixable on a wall of the vehicle.

14. The vehicle of claim 13, wherein the extension piece comprises a first bent line section arranged between the first extension section and the second extension section, and a second bent line section which is, related to the direction of flow of exhaust gas, arranged downstream on the second extension section.

15. The vehicle of claim 11, wherein the first extension section and the second extension section are aligned orthogonally to one another.

16. The vehicle of claim 11, wherein the line end piece is configured, related to the direction of flow of exhaust gas, to be mounted on the extension piece downstream of the second extension section.

17. The vehicle of claim 11, wherein at least one flexible exhaust gas pipe section and at least one flexible combustion air pipe section are arranged fluidically between the heating device and the end line assembly.

18. The vehicle of claim 11, wherein the line end piece or the extension piece is removably mounted in a plug style connection.

19. The vehicle of claim 11, wherein the vehicle is a caravan, motor home or ship.
